(19) United States
(12) Patent Application Publication
(10) Pub. No.: US 2001/0026452 A1
(43) Pub. Date: Oct. 4, 2001

(54) Aircraft ground floodlight

(76) Inventors: Bernd Ganzer, Lippstadt (DE); Norbert Koniczek, Lippstadt (DE); Peter Metzger, Bad Lippspringe (DE)

Correspondence Address: BIRCH STEWART KOLASCH & BIRCH, PO BOX 747, FALLS CHURCH, VA, 22040-0747, US

(21) Appl. No.: 09/820,723

(22) Filed: Mar. 30, 2001

(30) Foreign Application Priority Data
Mar. 31, 2000 (DE) 100 16 217.7

(51) Int. Cl. B64D 47/02

(52) U.S. Cl. 362/470; 362/514; 362/544; 362/247

(57) ABSTRACT

An aircraft floodlight includes a lens placed in front of a housing thereof, a gas discharge lamp that is provided along with a reflector, and an electronic power supply unit. The housing has at least two reflectors that are aligned at different angles to one another and generate overlapping cones of light.

### BACKGROUND OF THE INVENTION

1. Field of the Invention

This invention relates to aircraft ground floodlights, more particularly, to an aircraft ground floodlight having a housing with a lens placed in front thereof, a gas discharge lamp that is provided along with a reflector, and an electronic power supply unit.

2. Related Art

U.S. Pat. No. 5,813,744 describes an aircraft ground floodlight designed to function as a landing and/or ground light. The patented aircraft floodlight includes a housing having therein a reflector which is paired with a gas discharge lamp. The reflector is covered by a transparent lens. An additional lens is placed in front of the housing, or the reflector, in a direction of light emission originating from the gas discharge lamp. The illumination angles required by aviation authorities to illuminate an apron of a runway, when an aircraft is taking off and landing, are achieved by an optical effects created by the additional lens. In particular, parallel light emitted by the lamp and reflector is radiated at different angles due to the fact that the additional lens is divided into different regions of differing light refraction.

One disadvantage of the known floodlight is that a relatively high power consumption is necessary to achieve a desired illuminance level, but because of relatively high power loss, a great deal of heat is produced which shortens the life of the gas discharge lamp.

### SUMMARY OF THE INVENTION

The object of the present invention is to increase the life of the gas discharge lamp while simultaneously improving the illumination of the runaway apron as an aircraft is taking off and landing.

This object and other objects of the present invention are achieved by providing a housing having at least two reflectors aligned differently relative to one another, thereby producing overlapping cones of light.

The at least two reflectors paired with two gas discharge lamps provide improved illumination of the runaway apron. Moreover, the at least two reflectors structure of the present invention allows the use of gas discharge lamps having reduced power consumption; reduced power consumption reduces the amount of power lost by each gas discharge lamp, which creates less heat output and improves the life expectancy of the lamps. Furthermore, the redundancy of overlapping cones of light ensures sufficient light is available in the event one of the gas discharge lamps fails.

According to a preferred embodiment of the present invention, the housing has three reflectors that produce overlapping cones of light.

The use of three reflectors according to the present invention creates a greater light convergence, or a greater bundling, of emitted light as than state of the art. The stronger and improved bundling results in less scattered light and thus a lower risk of disruptive glare, which may be disconcerting to the flight crew, especially when flying through moist strata of air. Moreover, the use of three reflectors improves the luminous power and redundancy of the floodlight, which positively affects operating reliability.

According to another preferred embodiment of the present invention, the three reflectors are interconnected and are jointly adjustable with respect to the housing by means of a three-point adjustment.

The interconnection of the reflector ensures they can be easily adjusted relatively after the housing is installed in the aircraft fuselage.

According to a preferred embodiment of the present invention, the reflectors are designed as separate individual reflectors.

Using separate individual reflectors permits individual adjustment of a single reflector. Therefore, during an aircraft flight testing phase it is possible to optimize the illumination of the runway apron regardless of the aircraft model and/or design.

According to another preferred embodiment of the present invention, light diffusing optics are placed in front of the reflectors.

The use of light diffusing optics, placed in the lens of the reflector, achieves a desired diffusion effect.

According to another preferred embodiment of the present invention, the reflectors are integrally connected to form one cohesive reflector unit.

The use of interconnected reflectors yields an improved light bundling effect; furthermore, the interconnected reflectors eliminate the need for light diffusing optics, and simplify the assembly of the floodlight.

According to another preferred embodiment of the present invention, a power supply unit has three ballasts and a transformer to supply electric power to the gas discharge lamps. Therefore, each gas discharge lamp has a ballast facilitating control and monitoring of the individual gas discharge lamps, while at the same time redundancy is improved thereby increasing operating reliability.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of a floodlight according to the present invention with three separate reflectors and a housing, which is shown with dotted lines;

FIG. 2 is a side view of the floodlight illustrated in FIG. 1, as seen from direction II;

FIG. 3 is a perspective diagram of a floodlight according to the present invention with three reflectors integrally connected;

FIG. 4 is a side view of the floodlight illustrated in FIG. 3, as seen from direction IV, with the housing shown with dotted lines;

FIG. 5 is a front view of the floodlight illustrated in FIG. 4, as seen from direction V;

FIG. 6 is a top view of the floodlight illustrated in FIG. 5, as seen from direction VI; and

FIG. 7 is a circuit diagram of a electronic power supply unit according to the present invention.

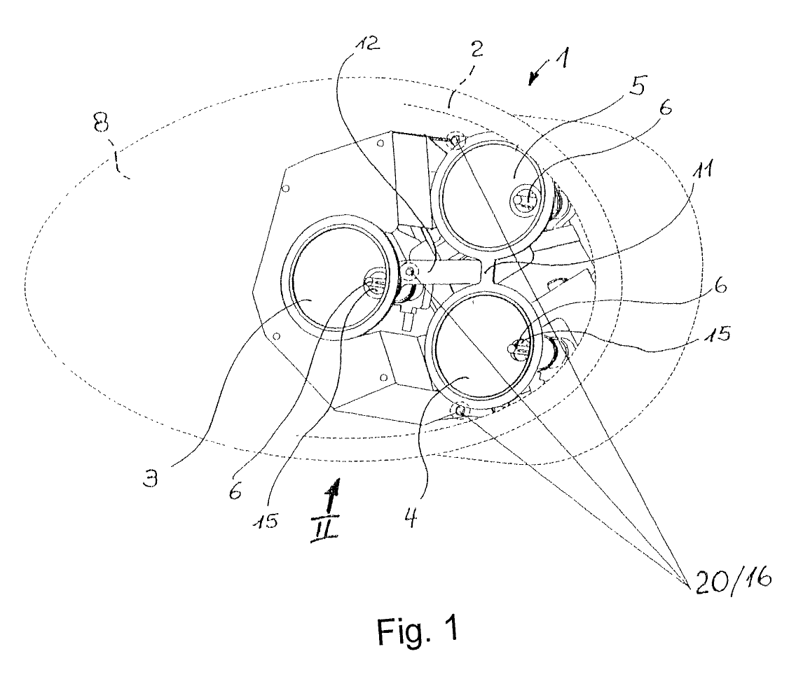

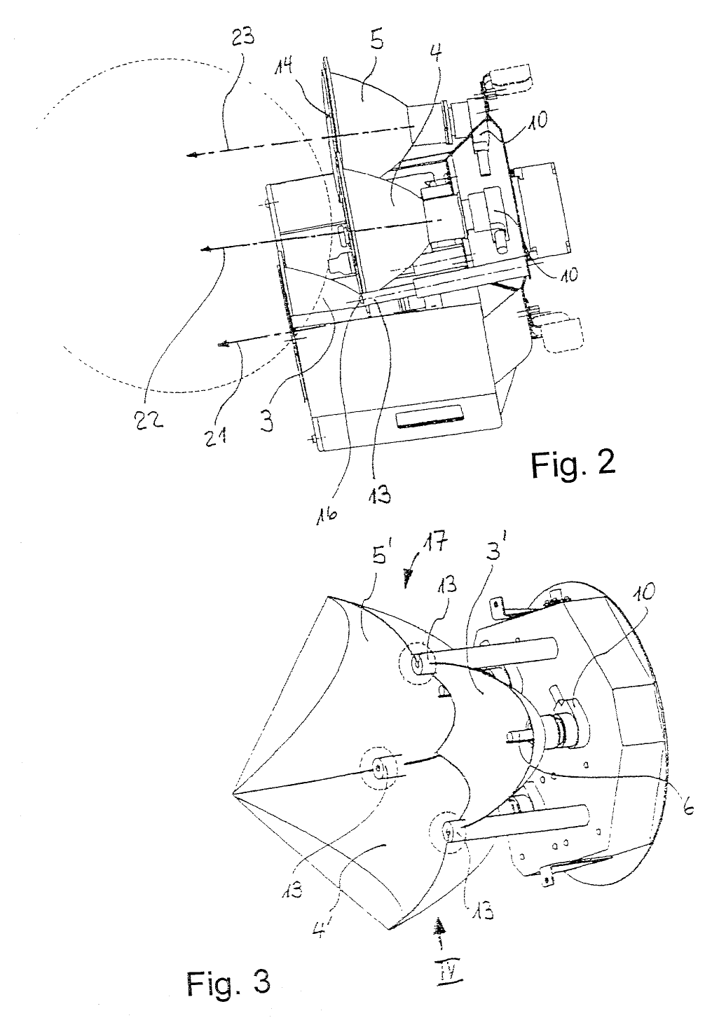

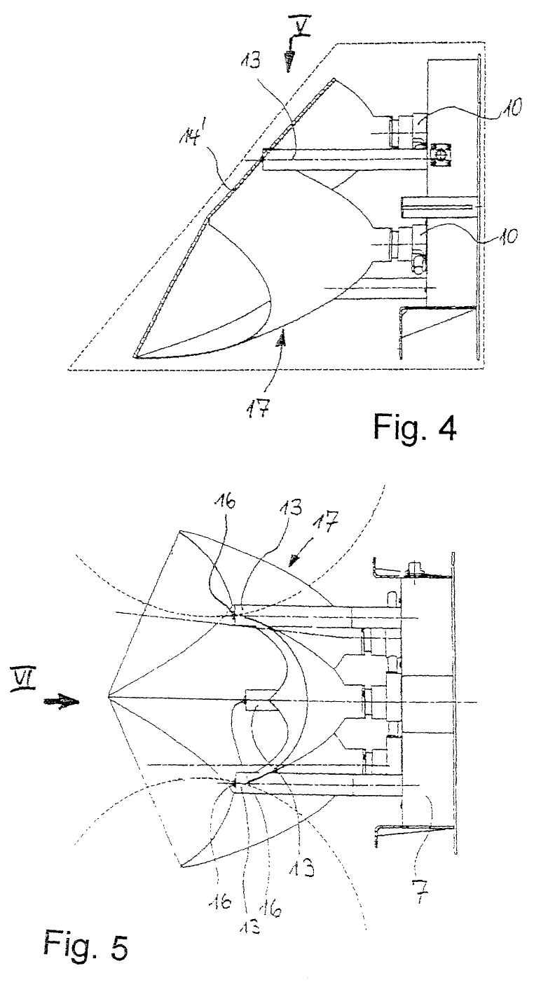

### DETAILED DESCRIPTION OF THE PREFERRED EMBODIMENTS

Referring to the Figures, and according to an embodiment of the present invention, an aircraft floodlight 1 includes a housing 2, a first reflector 3, a second reflector 4, a third reflector 5, gas discharge lamps 6 and an electronic power supply unit 7.

The housing 2 of the floodlight 1 is covered by a transparent lens 8 toward the outer skin of an aircraft fuselage (not shown here). The reflectors 3, 4 and 5 are arranged on a device mount 9 that faces away from the lens 8. The first reflector 3 is inclined at an angle of 1° to the horizontal, and the second reflector 4 is inclined at an angle of 5° to the horizontal. The third reflector 5 does not have any inclination. The different inclinations of reflectors 3, 4, 5, and their central beams 21, 22, 23, provide optimal runway apron illumination from the aircraft in any approach situation.

Reflectors 3, 4, 5 are each paired with a gas discharge lamp 6. Each of the gas discharge lamps 6 receives electric power by the electronic power supply unit 7, via at least one cable connector 10. The reflectors 3, 4, 5 are connected by webs or framing 11, 12. The reflectors 3, 4, 5 are adjustably connected to the housing 2 by three mandrels 13. The mandrels 13 are mounted in bushings which contain compression springs (not shown in detail here) to guarantee the respective alignment of the reflector group 3, 4, 5 and the floodlight 1 in the aircraft fuselage. For example, an adjustment of ±2.5° about the x and y axes is possible. The reflectors 3, 4, 5 are each covered by a transparent lens 14. Each lens 14 is secured elastically in the reflector 3, 4, 5, respectively, and fastened by a holding frame.

The gas discharge lamps 6, which may be 50 W HID lamps, for example, are centered accurately in a neck hole 15 in the reflectors 3, 4, 5 and secured by holding faces.

To replace a gas discharge lamp 6, the screws 16 that are provided on the mandrels 13 are loosened and the reflectors 3, 4, 5 are removed from the device mount. Then, the cable connector 10 of the gas discharge lamp 6 to be replaced is loosened, and the holding plate that belongs with it is removed. The discussed steps free the discharge lamp 6 for removal. The parts are assembled in the opposite order.

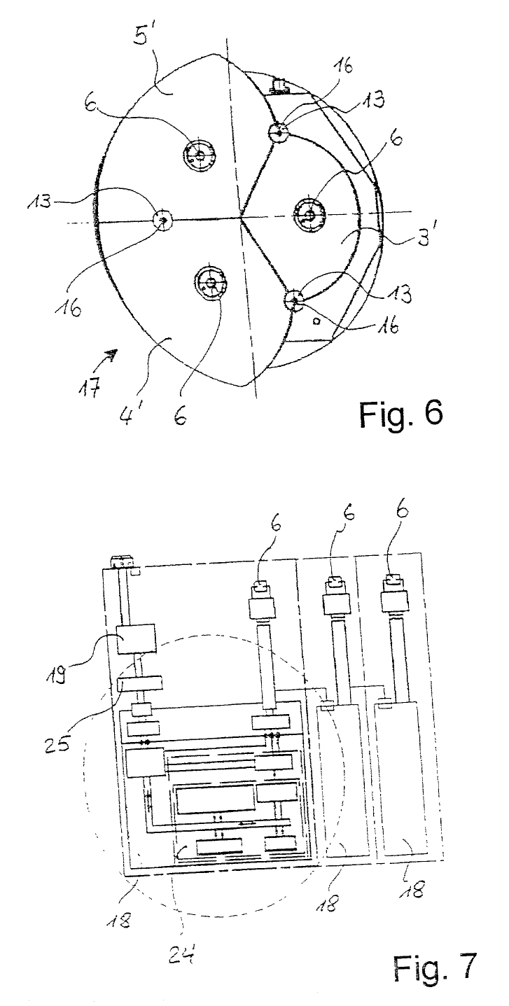

According to another embodiment of the present invention, the reflectors 3′, 4′, 5′ are connected to a reflector unit 17 (see FIG. 6). The reflectors 3′, 4′, 5′ are arranged and designed so light diffusing optics do not need to be used in front of the reflectors 3′, 4′, 5′. The reflectors 3′, 4′, 5′ are covered by a transparent lens 14′ without optics.

The electronic power supply unit 7 includes three ballasts 18 provided for the reflectors 3, 3′, 4, 4′, 5, 5′ and the gas discharge lamps 6, and a transformer 19 which converts the incoming on-board voltage from 115 V AC to 28 V DC. The startup voltage and operating voltage of the gas discharge lamps 6 are regulated and monitored in a control part 24 of each of the ballasts 18. An EMC filter 25 is placed between the transformer 19 and the first ballast 18 to ensure electromagnetic compatibility.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An aircraft floodlight, comprising:
a housing (2);
at least two reflectors (3, 3′, 4, 4′, 5, 5′) housed in the housing (2); and
a lamp (6) associated with each of the at least two reflectors (3, 3′, 4, 4′, 5, 5′),
wherein the at least two reflectors (3, 3′, 4, 4′, 5, 5′) are aligned at different angles to one another and generate overlapping cones of light.

2. The floodlight according to claim 1, wherein the housing (2) houses three reflectors (3, 3′, 4, 4′, 5, 5′) which generate overlapping cones of light.

3. The floodlight according to claim 1, wherein the reflectors (3, 3′, 4, 4′, 5, 5′) are covered by a transparent lens (14, 14′).

4. The floodlight according to claim 1, wherein the at least two reflectors (3, 3′, 4, 4′, 5, 5′) are interconnected and are adjustable jointly with respect to the housing (2).

5. The floodlight according to claim 2, wherein the three reflectors (3, 3′, 4, 4′, 5, 5′) are interconnected and are adjustable jointly with respect to the housing (2).

6. The floodlight according to claim 5, wherein the reflectors are adjustable by a three-point adjustment (20).

7. The floodlight according to claim 1, wherein the reflectors (3, 4, 5) are designed as separate individual reflectors.

8. The floodlight according to claim 7, wherein light diffusing optics are placed in front of the reflectors (3, 4, 5).

9. The floodlight according to claim 1, wherein the reflectors (3′, 4′, 5′) are integrall connected together to form one reflector unit (17).

10. The floodlight according to claim 1, further comprising a power supply unit (7) having three ballasts (18) and a transformer (19) for supplying electric power to the lamps (6).

11. The floodlight according to claim 1, wherein the lamps (6) are gas discharge lamps.
